(19) United States
(12) Patent Application Publication
(10) Pub. No.: US 2017/0248716 A1
(43) Pub. Date: Aug. 31, 2017

(54) DEVICE AND METHOD FOR WEIGHTED SPARSE INVERSION FOR SEISMIC PROCESSING

(71) Applicant: CGG SERVICES SAS, Massy Cedex (FR)

(72) Inventor: Gordon POOLE, East Grinstead (GB)

(73) Assignee: CGG SERVICES SAS, Massy Cedex (FR)

(21) Appl. No.: 15/521,647

(22) PCT Filed: Nov. 13, 2015
(86) PCT No.: PCT/IB2015/002516

§ 371 Date: Apr. 25, 2017

Related U.S. Application Data
(60) Provisional application No. 62/079,781, filed on Nov. 14, 2014.
(60) Provisional application No. 62/110,933, filed on Feb. 2, 2015.
(60) Provisional application No. 62/183,255, filed on Jun. 23, 2015.

(51) Int. Cl. G01V 1/28; G01V 1/36; G01V 1/32

(52) U.S. Cl. CPC G01V 1/282; G01V 1/32; G01V 1/364; G01V 2210/46

(57) ABSTRACT

Computing device, computer instructions and method for processing input seismic data d. The method includes receiving the input seismic data d recorded in a data domain, solving a linear inversion problem constrained by input seismic data d to obtain a model domain and its energy, wherein the linear inversion problem is dependent on sparseness weights that are simultaneously a function of both time and frequency, reverse transforming the model domain energy to the data domain, and generating an image of a surveyed subsurface based on the reverse transformed model domain energy.

### CROSS-REFERENCE TO RELATED APPLICATIONS

The present application is related to and claims the benefit of priority of U.S. Provisional Application 62/079,781, filed Nov. 14, 2014; U.S. Provisional Application 62/110,933, filed Feb. 2, 2015; and U.S. Provisional Application 62/183,255, filed Jun. 23, 2015, the entire contents of which are incorporated herein by reference.

### BACKGROUND

Technical Field

Embodiments of the subject matter disclosed herein generally relate to methods and systems for processing seismic data for improving an image of a surveyed subsurface and, more particularly, to mechanisms and techniques related to an inversion scheme for the processing of seismic data using sparseness weights that are a function of time and frequency.

Discussion of the Background

Seismic data acquisition and processing generates a profile (image) of the geophysical structure (subsurface) under the ground. While this profile does not provide an accurate location for oil and gas, it suggests, to those trained in the field, the presence or absence of oil and/or gas. Thus, providing a high-resolution image of the subsurface is an ongoing process for the exploration of natural resources, including, among others, oil and/or gas.

The seismic data may be marine (towed streamer, ocean bottom node (OBN), ocean bottom cable (OBC), etc.), land or transition zone. The sampling of the data may be 2-dimensional (2D), 3D, or wide-azimuth. The used sensors may be hydrophones, geophones, accelerometers, particle motion sensors, particle velocity sensors, differential pressure sensors, or another type of sensor. Data may relate to more than one sensor type. For example, this may relate to a combination of hydrophone and horizontal particle velocity data, hydrophone and vertical particle velocity data, hydrophone, vertical particle velocity and horizontal particle velocity, or another combination of sensor types. The seismic source may be of any type: impulsive or non-impulsive, airgun, marine vibrator, land vibrator, dynamite, mini-sosie, pinger, boomer, sparker, weight drop, etc.

An exemplary marine seismic acquisition system is illustrated in FIG. 1. During a seismic gathering process, a vessel 110 tows plural detectors 112, which are disposed along a cable 114. Cable 114 together with its corresponding detectors 112 are sometimes referred to, by those skilled in the art, as a streamer 116. Vessel 110 may tow plural streamers 116 at the same time. Streamers may be disposed horizontally, i.e., lie at a constant depth z₁ relative to the ocean surface 118. Also, plural streamers 116 may form a constant angle (i.e., the streamers may be slanted) with respect to the ocean surface as disclosed in U.S. Pat. No. 4,992,992, the entire content of which is incorporated herein by reference.

Still with reference to FIG. 1, vessel 110 may also tow a seismic source 120 configured to generate an acoustic wave 122a. Acoustic wave 122a propagates downward and penetrates the seafloor 124, eventually being reflected by a reflecting structure 126 (reflector R). Reflected acoustic wave 122b propagates upward and is detected by detector 112. For simplicity, FIG. 1 shows only two paths 122a corresponding to the acoustic wave. Parts of reflected acoustic wave 122b (primary) are recorded by various detectors 112 (recorded signals are called traces) while parts of reflected wave 122c pass detectors 112 and arrive at the water surface 118. Since the interface between the water and air is well approximated as a quasi-perfect reflector (i.e., the water surface acts as a mirror for acoustic waves), reflected wave 122c is reflected back toward detector 112 as shown by wave 122d in FIG. 1. Wave 122d is normally referred to as a ghost wave because it is due to a spurious reflection.

The recorded traces may be processed to determine an image of the subsurface (i.e., earth structure below surface 124) and to determine the position and presence of reflectors 126. The processing may involve an inversion scheme, which uses a model domain for modeling the earth. However, there are problems with the traditional inversion schemes as now discussed.

The following discussion about the limitations of the existing inversion schemes is given with relation to the parabolic Radon demultiple, but, most of the known inversion schemes have similar limitations. Radon methods have been used for many years for the attenuation of multiples energy in the case that the moveout of multiples is significantly different to that of primaries.

Radon demultiple is traditionally applied in the common midpoint (CMP; time-space domain) domain or common image point (CIP; time-space or depth-space domain depending on the variety of migration used) domain, but can also be applied in other domains where the signal takes a coherent appearance (for example, reflection angle gather), which may be modelled and removed from seismic data. The Radon model may be any domain describing a set of events, but is often the linear, parabolic, hyperbolic, shifted hyperbola, 3D parabolic (e.g., Hugonnet, et al. 2009, “High resolution 3D parabolic Radon filtering,” EAGE conference proceedings, 2009) Radon model. The model may be in 2 or more dimensions and may mix a number of different domains (e.g., tau-px-py-q, where p relates to linear move-out, and q relates to parabolic move-out).

Traditionally, the Radon domain (Hampson, 1986, “Inverse velocity stacking for multiple elimination,” 56th Annual International Meeting, SEG, Expanded Abstracts, Session: S6.7) was found by solving a linear set of equations which may generally be stated in the form of:

d=Lm (1)

for a parabolic model space in the frequency domain, where
d: Input CMP, N traces.
m: Parabolic Radon model domain, M traces.
L: Linear operator given by L(n, m)=e−^{2πifs}^{ₘ}^{h}^{ₙ}^{²};

### f: Frequency (Hz).

sₘ: Parabolic moveout of m^{th} model trace; (s/m/m).
hₙ: Offset of n^{th} trace in the gather.

The least squares Radon equations may be solved in the frequency or the time domain. Once the model domain m has been found, it is masked to form a representation of the multiples energy. The multiples are then reverse Radon transformed (by applying L) to make a model of multiples in the data domain. The multiples are then subtracted from the input data for estimating the primaries.

Hermann et al., 2000, (and associated patent U.S. Pat. No. 6,636,809) uses model domain weights to avoid the effect of aliasing on high frequencies. This approach often involves solving the least squares Radon for low frequencies, and using these as model constraints to guide the inverse problem for higher frequencies. This scheme steers the high frequency Radon model, constraining it to non-aliased model areas. The model constraints may be updated further with increasing frequency. Trad, D., Ulrych, T. and Sacchi, M. 2003 (“Latest views of the sparse Radon transform, Geophysics Vol 68, P386-399) also describes a way of solving such equations using sparseness. The sparseness weights may be updated iteratively, commonly known as iteratively re-weighted least squares. The terms sparse Radon transform and high resolution Radon transform are commonly interchanged.

While this approach is very effective, the use of low frequencies may not have high enough resolution to separate areas of primary and multiples where they are not distinctive enough in moveout.

The use of time domain Radon (e.g., Schonewille and Aaron, 2007, “Applications of time-domain high-resolution Radon demultiple,” SEG conference proceedings) has also been described in the literature. This method allows the use of sparseness in time as well as in slowness. However, sparseness in time is not always of advantage as in the case of diffracted multiples, or after the application of other demultiple methods or migration, as the multiples may be fragmented and no longer be sparse in time.

Frequency domain sparseness has the benefit of using the low frequencies to dealias the high frequencies, as described by Herrmann et al., 2000. However, the sparseness has no resolution in time and the time windowing often required to get this to work properly can cause edge effects particularly for low frequencies. In addition, aliasing at slownesses where there are primary events cannot be adequately avoided. While time domain implementations solve some of these problems, they no longer have the ability to vary the sparseness with frequency.

Thus, there is a need for a new inverse method that overcomes the above noted disadvantages.

### SUMMARY

According to an embodiment, there is a method for processing input seismic data d. The method includes receiving the input seismic data d recorded in a data domain, solving a linear inversion problem constrained by input seismic data d to obtain a model domain and its energy, wherein the linear inversion problem is dependent on sparseness weights that are simultaneously a function of both time and frequency, reverse transforming the model domain energy to the data domain, and generating an image of a surveyed subsurface based on the reverse transformed model domain energy.

According to another embodiment, there is a computing device for processing input seismic data d. The computing device includes an interface that receives the input seismic data d recorded in a data domain, and a processor connected to the interface. The processor is configured to solve a linear inversion problem constrained by input seismic data d to obtain a model domain and its energy, wherein the linear inversion problem is dependent on sparseness weights that are simultaneously a function of both time and frequency, reverse transform the model domain energy to the data domain, and generate an image of a surveyed subsurface based on the reverse transformed model domain energy.

According to still another embodiment, there are computing systems and computer-readable mediums including computer executable instructions, wherein the instructions, when executed by a processor, implement one or more of the methods as noted in the above paragraphs.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic data acquisition system having a horizontal streamer;

FIG. 2A schematically illustrates seismic data d represented in a first domain;

FIG. 2B schematically illustrates a model domain representative of the data d, in a second domain different from the first domain;

FIG. 3 is a flowchart of a method for processing seismic data with sparseness weights that depend as a function of both time and frequency;

FIG. 4 is a flowchart of a method for processing seismic data based on a seismic data set and weights calculated with another data set;

FIGS. 5A-G illustrate an image of the surveyed subsurface calculated with various methods;

FIGS. 6A-H illustrate another method for processing seismic data using weights;

FIG. 7 is a flowchart of a method for processing seismic data based on sparseness weights;

FIG. 8 if a flowchart of still another method for processing seismic data based on sparseness weights;

FIG. 9 illustrates primaries and multiples in a marine environment;

FIG. 10 illustrates a receiver peg-leg multiple generated from a deeper primary; and

FIG. 11 is a schematic diagram of a computing device configured to implement one or more of the methods discussed herein.

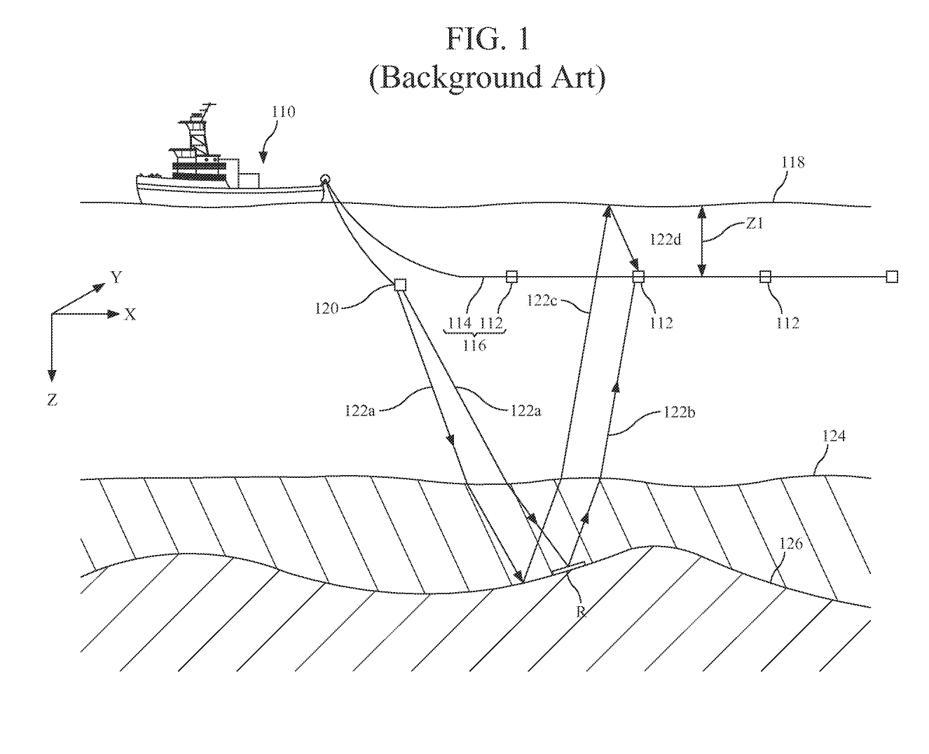

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a Radon domain. However, the novel embodiments may be applied to other domains.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, instead of using a time or frequency dependent Radon domain, a time and frequency Radon model is defined and used for the inversion scheme. In one embodiment, sparseness weights that are function of both the time and frequency are used to calculate the model domain. In another embodiment, the model domain in the Radon domain is allowed, for all spatial windows, to be derived simultaneously to avoid potential edge effect issues.

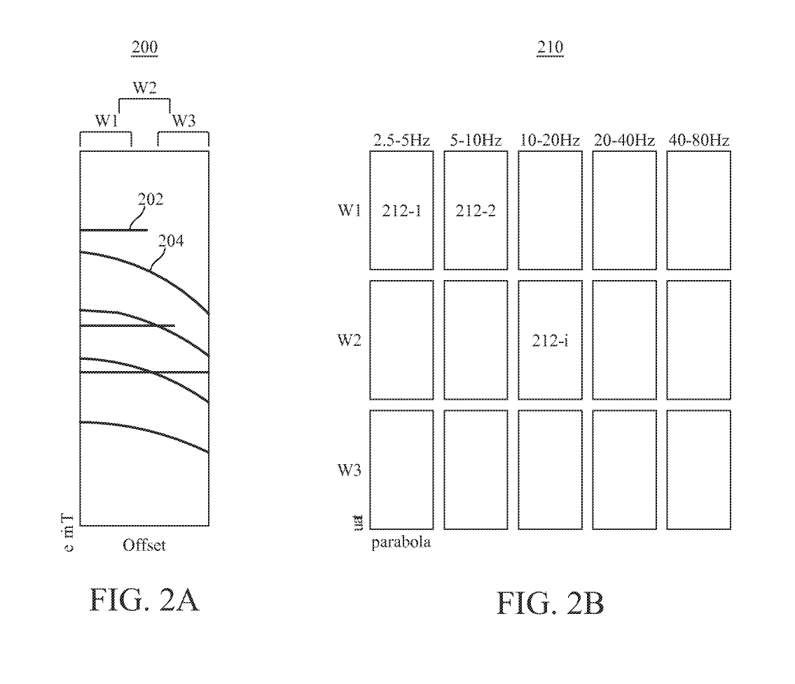

In one embodiment the Radon domain may be defined as a number of tau-q (for the case of parabolic Radon) models for different octaves (also known as wavelet scales) and spatial windows Wᵢ as shown in FIGS. 2A-B. While FIG. 2A shows the data domain 200 (measured in the time-space domain), FIG. 2B shows the Radon domain 210. Data domain 200 shows primaries 202 and multiples 204 in the time-space domain. Note that the offset indicated on the x axis is the distance between the source and a respective receiver. Radon domain 210 shows the tau-q model domains 212-i, each model having tau (vertical) and q (horizontal) coordinates. The first column of the model domains corresponds to a first frequency range of 2.5 to 5 Hz (the first octave), the second column of model domains corresponds to a second frequency range of 5 to 10 Hz (the second octave) and so on. Note that an octave is defined by a frequency range fᵢ to f_{f}, where f_{f} is twice fᵢ. In one embodiment, the approach is not limited purely to octaves. For example, each model may use a range of 10 Hz, or any set of defined bandpass filters. The first row of the model domains 212-i corresponds to a first spatial window W₁, the second row of the model domains corresponds to a second spatial window W₂, and so on. Note that windows Wᵢ are spatial windows selected in the data domain 200. The range of tau for each spatial window 212-i will often approximately be the same as the time range on the input gather 200. The windows may optionally also be selected in the time direction.

The number of rows and columns in the Radon domain 210 may vary. For example, it is possible to have only one row if spatial windowing is not used. Alternatively, it is possible to process different spatial windows independently rather than within a single inversion as described. The frequency ranges and spatial windows allow the Radon domain to depend on the time (tau) and frequency of the seismic data d from the time-space domain 200. Thus, the Radon domain (or each model domain 212-i) is considered herein, to also have a time and frequency dependency. To avoid confusion between Radon domain and time-frequency domain, it is introduced herein the concept of having a Radon domain (or model domain) with time-frequency dependency. This novel concept allows defining quantities in the Radon domain that have a time-frequency dependency, as now discussed.

It should be understood that each octave may be defined with Butterworth filters (a filter that is designed to have as flat a frequency response as possible in the passband) or frequency slope filters, which means there will be some overlap in frequency between each octave. Normally, whatever filter scheme is used, the sum of the filter for all octaves at a given frequency will normally be constant (usually 1), with the exception of a low frequency and/or high frequency filter to mitigate noise as required. In the case the sum of the filter for all octaves is not constant, the inversion will give preference to some frequencies over others. Other filtering schemes can be used, for example frequency-wavenumbers (FK) filters, K-filters, curvelets, contourlets, ridgelets, wavelets, seislets, etc. The filtering schemes used may be in one dimension or in more than one dimension.

While it would be possible to form a linear equation for this problem, in practice, the matrices would be very large and costly to solve. For this reason, it is common to solve such problems using conjugate gradients. Conjugate gradient solvers iteratively update the model domain, each time with more accuracy. The linear operators for parabolic Radon may be applied as noted below:

L—Transform from Model Domain m to Data d
1) Convolve each model domain with its respective bandpass filter;
2) Reverse tau-q transform each model domain from the tau-q domain to the x-t domain, for example, reverse parabolic stack. This transform may be applied in the time or frequency domain;
3) Sum all frequency bands for each window together;
4) Taper the x-t representation for each spatial window; and
5) Combine the spatial windows to form the CMP gather (i.e., data d).
L^{T}—Transform from Data d to Model Domain m
1) Separate/duplicate the data from the CMP gather into spatial windows Wᵢ, (see FIG. 2A);
2) Taper each of the spatial windows;
3) Transform each window from x-t to tau-q domain, for example, using a forward parabolic stack (see FIG. 2B). This transform may be applied in the time or frequency domain;
4) Duplicate tau-q domain for each bandpass; and
5) Convolve with bandpass filters.

Iterative application of linear operators L and L^{T} (adjoint) converge to derive a model domain m. This formulation for the Radon domain is very flexible and allows the use of sparseness weights in 4D space, i.e., space, time (tau), frequency, and parabola. The sparseness weights may be derived from low frequencies and applied to higher frequencies (e.g., Herrmann et al., 2000). However, in order to achieve higher resolution, it may be advantageous to initially set the sparseness weights set on higher bandwidths.

One such strategy may be to set sparseness weights on the highest non-aliased wavelet scale. The term “scale” is understood herein to mean an octave index. The frequency relating to such a scale may depend on the maximum slowness in each temporal window Wᵢ. Such a quantity may be calculated as follows:

t=qₘₐₓhₘₐₓ² (2)

The slowness is given by:

$$\frac{dt}{dh} = 2 {q}_{max} {h}_{max} = \frac{K}{{f}_{max}} = \frac{1}{Δ {hf}_{max}} \qquad ( 3 )$$

### Therefore,

$${f}_{max} = \frac{1}{2 {q}_{max} Δ {hh}_{max}} \qquad ( 4 )$$

where:
t—Moveout time (s);
qₘₐₓ—Maximum parabolic moveout parameter in the model (s/m²);
hₘₐₓ—Maximum offset for a given window (m);
K—Wavenumber (m⁻¹);
fₘₐₓ—Maximum frequency beyond which aliasing occurs (Hz); and
Δh—Offset spacing or maximum offset spacing (m)

The procedure may begin by solving the problem with least squares by setting the sparsity to, for example, 1. An alternative may be to initiate the sparseness with prior information. This information may relate to a scan of the energy in the data windows. Alternatively, it is possible to initiate the inversion with a v-shaped cut in the sparseness weights at the position of the primary-multiple cut. This will encourage the initial inversion result to naturally attempt to separate primaries and multiples by not allowing energy to spread across the multiple-primary boundary.

After solving the above discussed linear system using least squares inversion, it is possible to derive sparseness weights based on the model domain m, for example, using the highest frequency non-aliased model (for example by calculating the envelope of the model domain in the tau and/or q direction, i.e., an envelope of each trace may be calculated according to known algorithms). Note that the highest frequency for the non-aliased model can be calculated based on equation (4). These sparseness weights may then be used for adjacent scales or all scales as necessary. The weights may be calculated, or re-defined as necessary after subsequent solutions of the weighted linear equations (iteratively re-weighted least squares as disclosed in Trad et al., 2003). The weights may be derived to be as flexible as required, and may vary for each window, tau, q, and scale. For example, after a first iteration, it is determined the highest frequency and the highest frequency non-aliased model. For the next iteration, weights are calculated (with any known method) based on the non-aliased model and applied to the aliased models. The algorithm continues to do this until all the models are non-aliased. The algorithm may simultaneously calculate all the model domains for all windows Wᵢ, with a single inversion. In an alternative embodiment, the algorithm simultaneously calculates all the model domains, one window at a time.

The tau-p envelope may be raised to a given power to change the aggressiveness of the sparseness. This power may vary with time, slowness, frequency, etc. For example, it is possible to have high sparseness near the demultiple cut, but lower sparseness away from the cut. This means that the multiple estimate will be sharp (although more synthetic looking) near the cut where primary/multiple separability is problematic, but lower sparseness power away from the cut where primary/multiple separability is not a problem.

Alternatively, model domain sparseness weights may not be based on an envelope but instead on a different function of the model domain. For example, the square of the model, the absolute of the model, the running average of the absolute of the model in the time and/or parabola direction.

Sparseness weights may be set across different spatial windows Wᵢ. For example, FIG. 2A illustrates that windows W₁ to W₃, which extend along the time axis, are selected along the space axis. For example, sparseness weights from the second spatial window W₂ (which has more move-out discrimination) may be used for spatial window W₁ (where move-out discrimination is reduced). The process forces the inversion for the first spatial window to have energy in the positions in the tau-p domain that are used for the second window, thus giving potential for more move-out separability between primary energy and multiples energy.

Areas relating to multiples of a first window in the Radon model may be based on a parabolic cut, or may be based on the Radon model for a second window. One example uses a longer offset spatial window to define regions of multiples for a shorter offset window of the same CMP. Cuts may vary with offset, with time, with frequency, or a combination of model/data parameter space.

Sparseness weights may also be derived on an interpolated or decimated version of the data, or from another dataset (for example another vintage of a time-lapse (4D) study).

In addition to model domain sparseness weights, data (offset-time) domain weights may also be used. Such weights may follow a mute function and may include a taper as necessary. Such data weights may be calculated, for example, by calculating a degree of confidence of the input data d, which may depend with time, frequency (e.g., octave) and offset, and associating the weights with the level of confidence. Various algorithms are known in the art for calculating the degree or level of confidence. This will have the effect that the model only needs to satisfy the input data within the weighted area. In addition, noisy traces or trace segments (e.g., those affected by swell noise, residual multiple, cross-talk or interference noise) may be given lower weights so as to limit their influence on the model domain. The weights may depend with the time, frequency, or both time and frequency. One embodiment relating to the use of data domain sparseness weights may be used to re-construct data significantly affected by impulsive noise.

Using data and model domain weights, the inverse scheme's linear operators discussed above may be re-defined as follows:

L—Transform from model domain m to data d
1) Multiply each model domain by corresponding model domain weights;
2) Convolve each weighted model domain with its respective bandpass filter; 3) Reverse tau-q transform each weighted model domain from the tau-q domain to the x-t domain;
4) Sum all frequency bands for each window together;
5) Taper the x-t representation for each spatial window;
6) Combine the spatial windows to form the CMP gather; and
7) Multiply the calculated data by data domain weights.
L^{T}—Transform from data d to model domain m
1) Multiply the data d by data domain weights;
2) Separate/duplicate the weighted data from the CMP gather into spatial windows;
3) Taper each of the spatial windows;
4) Transform each window from x-t to tau-q domain with the L^{T} operator;
5) Duplicate tau-q model domain for each bandpass;
6) Convolve the model domain with bandpass filters; and
7) Multiply the convolved data by model domain weights.

In the case that data domain sparseness weights are a function of time and frequency, step (4) in the flow for L would be placed at the end, and steps (5) and (6) for the L^{T} flow would be moved to the start.

Once the model domain has been found, it should be multiplied by the model domain weights as described in Trad et al., 2003.

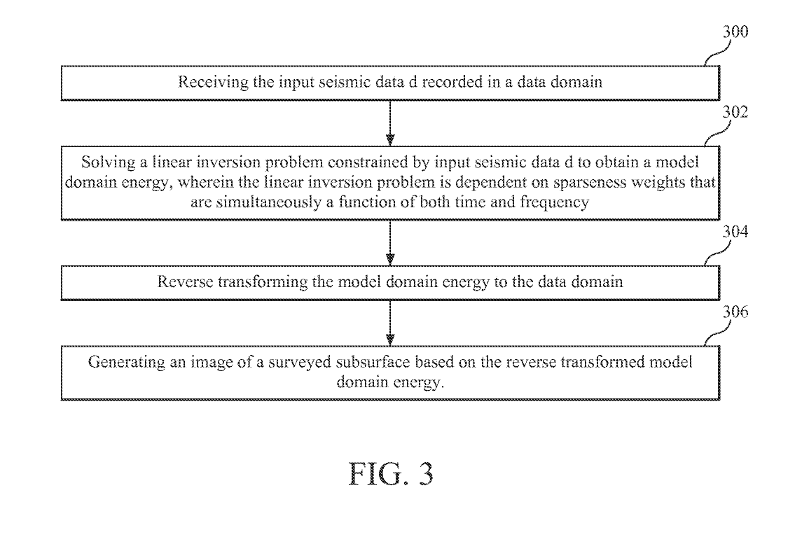

The method discussed above may be summarized as follows. According to FIG. 3, the method includes a step 300 of receiving seismic data d recorded in a data domain, a step 302 of solving a linear inversion problem constrained by input seismic data d to obtain a model domain energy, wherein the linear inversion problem is dependent on sparseness weights that are simultaneously a function of both time and frequency, a step 304 of reverse transforming the model domain energy to the data domain, and a step 306 of generating an image of a surveyed subsurface based on the reverse transformed model domain energy.

In one application, the model domain includes plural model domains, each model domain representing at least two time and/or space windows. The plural model domains are simultaneously calculated while solving the inverse problem. The inverse problem uses an iterative approach that repeatedly applies operator L to a calculated model domain and adjoint operator L^{T} to estimated data.

In one application, the model domain m is simultaneously calculated using representations pertaining to several windows Wᵢ of seismic data d. In one application, the windows, at least in part, overlap and the model domains are derived in a single inversion step. In another application, the inversion problem is solved using sparseness weights for a first frequency range (e.g., first octave in FIG. 2B) based at least, in part, on a second frequency range (e.g., second octave in FIG. 2B), where the second frequency range is at least in part higher than the first frequency range.

In one embodiment, the inversion problem is solved using sparseness weights for one window Wᵢ of data based, at least in part, on the data pertaining to a second window of data Wⱼ. In still another embodiment, areas of signal and noise are separated in a model domain relating to a first spatial window of data based on data relating to a second window of data.

The term sparse inversion in this context may relate to the solving of a mathematical system of equations for seismic exploration. The method may also relate to an iterative data cleaning scheme similar to a time-frequency domain version of the anti-leakage Fourier transform or matching pursuit methodology.

The method discussed in the embodiment describes a windowed Radon method which combines different spatial windows as part of the inversion (rather than processing each window independently and combining the results afterwards). This strategy optionally allows the flexibility of having different window sizes for different frequency bands (e.g., wavelet scales). For example, it is possible to have a large spatial window for low frequencies, and smaller spatial windows for high frequencies. The derivation of more than one model domain at the same time, each representing a different spatial window, may be combined with model domain, data domain, or data-model domain sparseness weights. The sparseness weights may be in the time domain, frequency domain, or the time and frequency domain. While these embodiments are discussed with reference to the Radon domain, those skilled in the art would understand that other domains may also be used.

One example relates to the context of optimized (e.g., least squares or other norm) migration where the aim is to derive a migrated image which optimally represents the input data after demigration. The demigration may relate to a Kirchhoff, beam or wave equation migration. The migrated image may be post stack or pre-stack. The input to the process may also be post-stack or pre-stack. Note that the input may be pre-stack, and the migrated image post-stack or vice versa. The migration may be a time migration or a depth migration. It is possible to derive a representation of a migrated image, represented by a number of tau-px-py models, each representing different overlapping spatial areas of a migration image. The tau-px-py models may be derived so that each model is reverse transformed to a spatial area. Each spatial area is tapered back together to form a migrated image. Then when the migrated image is demigrated, it should optimally represent the input data. This process may be defined as a linear operator consisting of several steps, L:
1) Reverse slant a plurality of tau-px-py models, each representing a different spatial window in a migrated domain;
2) Spatially taper the spatial windows;
3) Sum together the tapered spatial windows to form a migrated image; and
4) Demigrate the migrated image.
   The adjoint operation, L^{T} may be defined as:
   1) Migrate the data;
   2) Select a plurality of spatial windows;
   3) Spatially taper the spatial windows; and
   4) Forward slant the tapered spatial windows to form a plurality of tau-px-py transforms.

L and L^{T} may be used as part of a conjugate gradients solver to find an optimal image. The plurality of tau-px-py models may be derived using model domain, data domain, or joint data-model domain sparseness weights. The model may be in the time, depth, frequency, wavenumber of a combination of dimensions, e.g. time and frequency, or depth and wavenumber. Different models may be used, for example parabolic, linear, hyperbolic, etc. The model may be in one or more spatial dimensions, for example, tau-px-py-q, where q is parabolic moveout in the offset direction.

While much of the discussion has focused on spatial windows, it should be understood that the windows may be in one or more spatial directions, but they also may be in the time direction.

In another embodiment, the derivation of sparseness weights (e.g., time, frequency or time and frequency domain) is performed using a more densely sampled version of the dataset. The densely sampled data may be generated in a variety of ways, including but not being limited to: data interpolation, e.g., fx interpolation, Gulunay interpolation, Porsani interpolation, etc., data regularization, e.g., anti-leakage Fourier transform, matching pursuit, dealiased matching pursuit, model driven interpolation, trace duplication with or without differential normal move-out (NMO), e.g., traces from adjacent shot gathers, receiver gathers, bins, cmps, offset class, azimuth class, stack, partial stack, etc. More specifically, differential NMO is a technique that corrects the offset of traces based on their offset to the source. In this case, differential NMO means applying NMO to a measured trace, changing the header of this trace to reflect another offset, and reversing the NMO to obtain a trace at the another offset, another available dataset in the region: e.g., an alternative vintage of a time-lapse dataset, or an alternative survey in a survey merge, or other data type, e.g., when processing towed streamer data, it is possible to use OBN/OBC data covering the same area.

All these methods may be applied in combination with wraparound NMO.

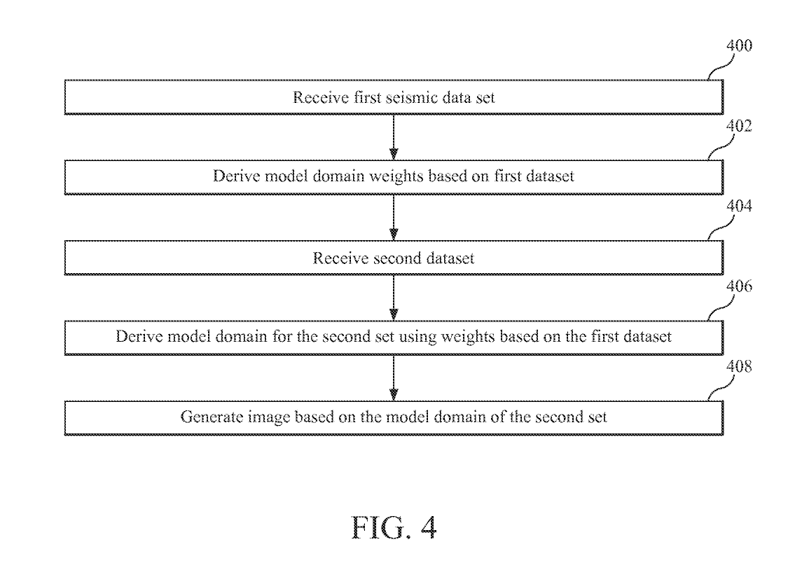

The strategy for determining the sparseness weights according to this embodiment is now discussed with regard to FIG. 4. In step 400, a first dataset of seismic data is received. In step 402, sparseness weights are derived for a first model domain corresponding to the first dataset. In step 404, a second dataset is received. The first dataset is more densely sampled than the second dataset. The second dataset may be a sub-set of the first dataset. In step 406, a second model domain of the second dataset is derived using the sparseness weights calculated using the first dataset. The model domains for the first and second datasets may be the same size or different sizes. In step 408, an image of the subsurface is generated based on the primaries and/or multiples calculated in the second model domain.

This method has been implemented on a dedicated computing device for the case of streamer interpolation using the tau-px-py domain. Starting with unity model domain sparseness weights (I2 norm), the iteratively re-weighted least squares solver refines the model weights with successive solutions to a least squares solver as described in Trad et al., 2003. The following methods for calculating the weights are now compared:

1) Unity sparseness weights (equivalent to I2 norm);
2) Sparseness weights iteratively defined beginning with low frequencies to dealias high frequencies (as discussed above);
3) Sparseness weights initially derived from a 50 m cable spacing (constructed using differential NMO); and
4) Sparseness weights initially derived from a 25 m cable spacing (constructed using differential NMO).

Pseudo-code instructions for the frequency driven iteratively re-weighted solver (method 2)) is as illustrated below:

1. Set sparseness weights to unity,
2. Update sparseness weights

a) Optional bandpass the input data,

b) Solve weighted least squares problem using the method outlined in Trad et al, 2003, and

c) Calculate sparseness weights based at least in part on the result from 2b)

d) Go back to step 2a)

With each iteration, the high cut of the bandpass filter in step 2a) may be increased. For example, the method may start with a 15 Hz high cut for iteration no. 1, move to a 30 Hz high cut for iteration no. 2, and so on.

In the case that a more densely sampled dataset is used to constrain the sparseness weights, as illustrated in FIG. 4, the above flow is modified as follows:

1. Set sparseness weights to unity;
2. Update sparseness weights,

a) Optional bandpass of the input data,

b) Optional decimation of the input data,

c) Solve weighted least squares problem using the method outlined in Trad et al, 2003, and

d) Calculate sparseness weights based at least in part on the result from 2c)

In this case, the solver may begin with 25 m streamer spacing for the first iteration. For the second iteration, the 50 m streamer spacing is used, and for the third iteration, only the recorded 100 m streamer spacing data may be used as input.

Other flows may also be envisaged, two of which are given below.

### Flow 1

Iteration 1) 25 m differential NMO data, 15 Hz max freq.
Iteration 2) 25 m differential NMO data, 30 Hz max freq.
Iteration 3) 25 m differential NMO data, 60 Hz max freq.
Iteration 4) 50 m differential NMO data, 90 Hz max freq.
Iteration 5) 100 m recorded data, 120 Hz max freq.

Even though the input seismic data to iteration 5 contains only the recorded data, the sparseness weights have been constrained using more finely spaced streamers in the previous iterations. In this case, the more finely spaced data came from a copying of input data with differential NMO.

Alternatively, another flow may begin the first iteration with a 50 m spacing:

### Flow 2

Iteration 1) 50 m differential NMO data, 15 Hz max freq.
Iteration 2) 50 m differential NMO data, 30 Hz max freq.
Iteration 2) 50 m differential NMO data, 60 Hz max freq.
Iteration 4) 50 m differential NMO data, 90 Hz max freq.
Iteration 5) 100 m differential NMO data, 120 Hz max freq.

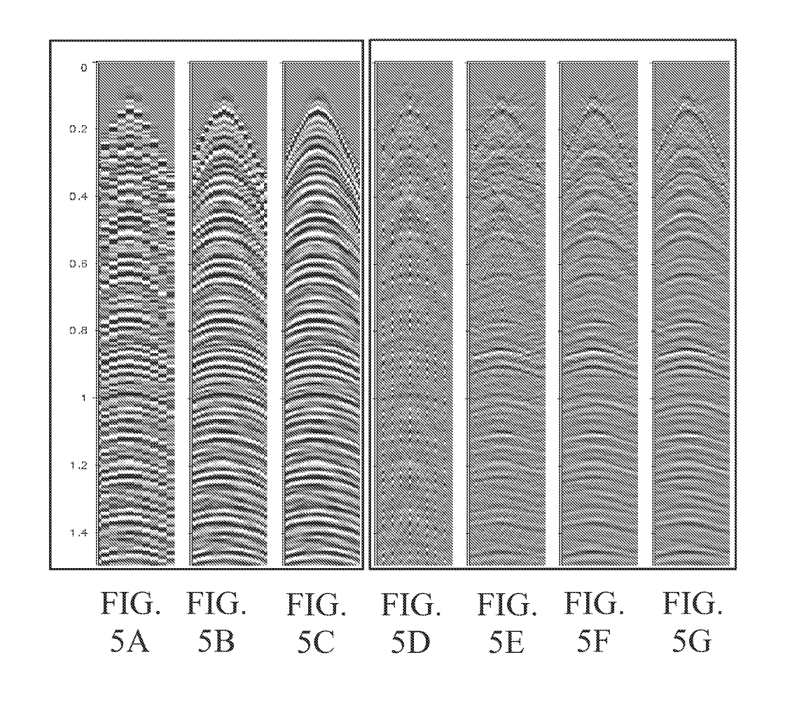

Interpolation comparison results showing the near channel across all streamers are illustrated in FIGS. 5A-G. FIG. 5A shows the originally recorded data d with 100 m streamer spacing, FIG. 5B shows the data corresponding to 50 m streamer spacing generated using differential NMO, FIG. 5C shows the data corresponding to 25 m streamer spacing generated using differential NMO, FIG. 5D shows the data corresponding to tau-px-py streamer interpolation using I2 norm, FIG. 5E shows the data corresponding to tau-px-py streamer interpolation using sparseness weights based on increasing frequency, FIG. 5F shows the data corresponding to tau-px-py streamer interpolation using Flow 1 and FIG. 5G shows the data corresponding to tau-px-py streamer interpolation using Flow 2.

As can be seen from FIGS. 5E-G, the interpolation of data using sparseness weights constrained by the finer sampled data (in this case differential NMO) has resulted in a more spatially consistent interpolation. Other sparseness schemes may be used and the model domain may be in a different domain to that given in this example, e.g., fk, tau-q, tau-p, hyperbolic radon, time or depth migrated domain, etc.

In general terms, it is possible to consider one or more steering datasets, which are used to derive sparseness weights, to derive a model for a main dataset. The above discussion related to the case that the steering dataset was more densely sampled than the main dataset. In another embodiment, the steering dataset may contain more measurements than the main dataset. For example, the steering dataset may contain hydrophone and particle velocity data, and the main dataset may contain only hydrophone data. For example, in the context of receiver deghosting, it is possible to first derive a ghost free model of the input derived using hydrophone and particle velocity data (for example, following Poole, G., “Device and method for wave-field reconstruction, US patent application publication no. US 2015/0212222.) Next, it is possible to calculate sparseness weights from the model. Then, it is possible to use the sparseness weights for a second inversion using only hydrophone data. The model from the second inversion may be used to separate up-going and down-going wave-fields, attenuate noise, or to reconstruct data at positions (in depth or x/y) away from the input data, etc. The dealiasing properties of horizontal particle velocity data is well known. A first model or interpolation filter may be derived using hydrophone and horizontal particle motion data. Sparseness weights may be calculated using this model and the weights are used to constrain a second inversion using only the hydrophone data. Other variations of taking a sub-set of a first dataset may also be used.

In yet another embodiment, a method for deriving sparseness weights for high resolution transforms is discussed. As discussed above, Radon demultiple aims to separate signal (primaries) and noise (multiples) using a difference in kinematics of the arrivals (e.g., parabolic move-out). In one example, this separation may relate to the following flow:

1) Input data d in CMP domain after NMO correction;
2) Derive a parabolic Radon representation (i.e., model domain m) of the CMP;
3) Select multiples by Radon domain muting of energy relating to primaries;
4) Reverse transform the multiple estimate back to the time-space domain; and
5) Subtract the multiples from the input data d.

As discussed in the previous embodiments, the sparseness weights may avoid the effect of aliasing on the high frequencies. The embodiments to be discussed next are different from the previous in the sense that the sparseness weights are used now to encourage better signal/noise (especially coherent noise) separation.

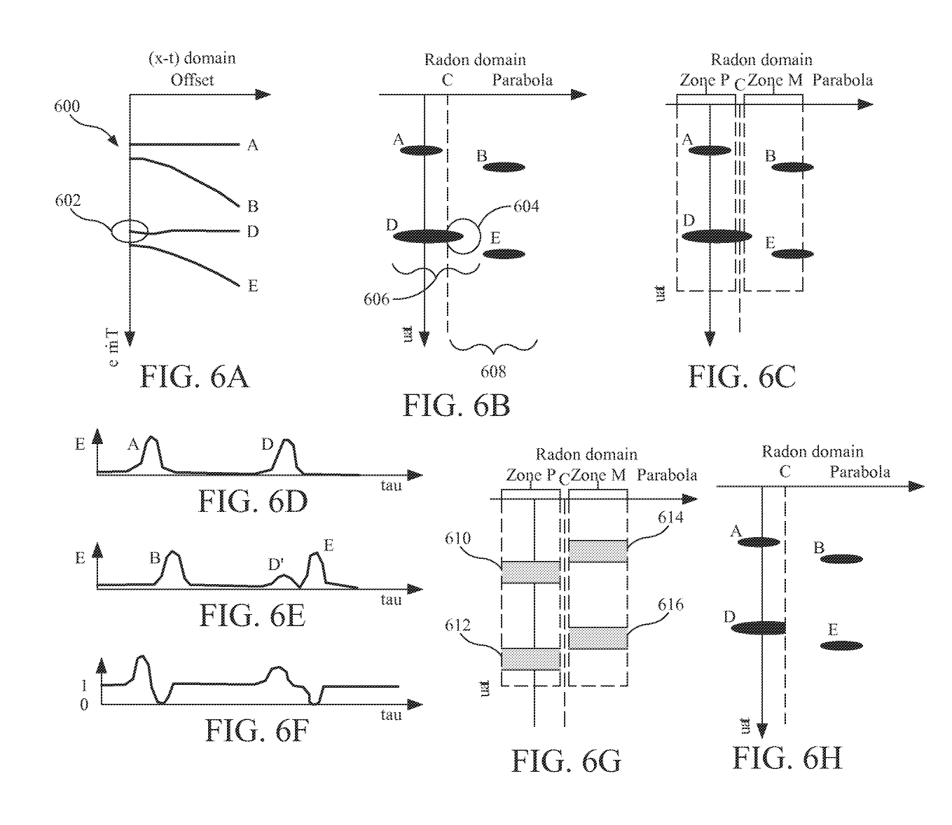

According to an embodiment, consider a CMP gather 600 with two primaries A and D and short period multiple energy B and E, as shown in FIG. 6A. Primary A has been flattened with NMO processing and in the parabolic Radon domain illustrated in FIG. 6B, it may be differentiated from multiple B at the parabola value indicated by C. The value C indicates the primary/multiples cut. Primary D, on the other hand, has not been flattened so well by the NMO processing and, as such, the near offsets 602 are dipping downwards slightly, as shown in FIG. 6A. In this case, some part 604 of the energy 606 relating to primary D would be in the multiple region 608 (i.e., to the right hand side of parabola C in FIG. 6B), thus resulting in primary damage. For reference, a second multiple E is also displayed.

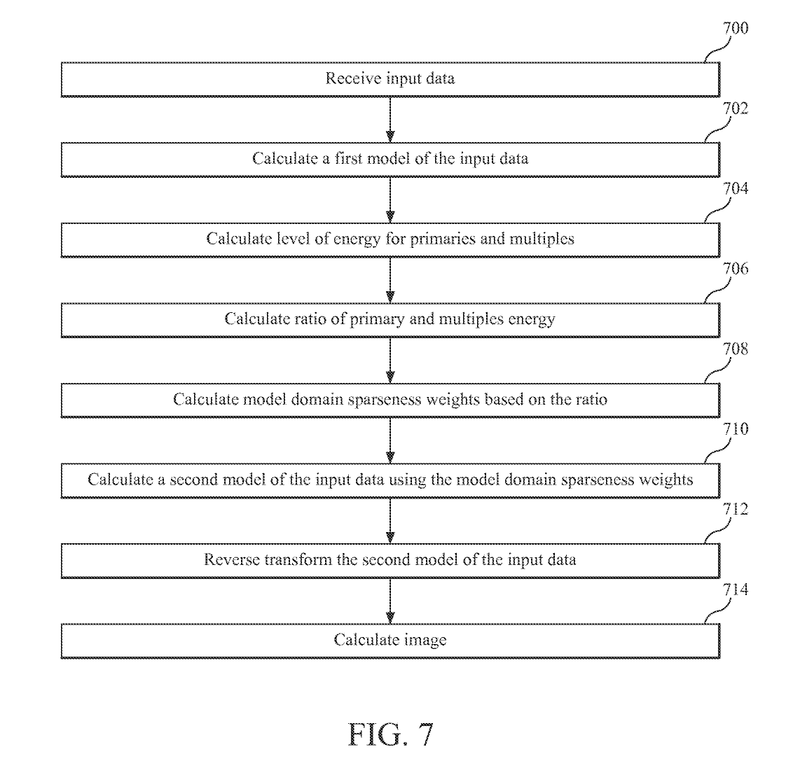

To minimize this damage, according to an embodiment, model domain sparseness weights are introduced to manipulate the distribution of energy in the Radon domain to better separate primary and multiple energy. This novel strategy begins, as illustrated in FIG. 7, with step 700 in which seismic data is received. In step 702, a first model domain corresponding to the seismic data is calculated, for example, in the Radon domain. The first model domain is then used in step 704 to calculate the level of energy in zones P and M (where P stands for primary and M for multiples), as shown in FIG. 6C. The energy may be calculated for each tau-slice, for the range of parabolas in each zone, and then the energies for the P and M zones are plotted as lines as shown in FIGS. 6D and 6E, respectively (the figures show the energy's amplitude versus tau). For each tau-slice, the ratio of the primary energy and the multiple energy is calculated in step 706, as illustrated in FIG. 6F. Based on the analysis of primary and multiple energy distribution shown in FIG. 6F, model domain sparseness weights are calculated in step 708 to penalize the model domain in certain areas with a view to better separate primary and multiple energy. Then, in step 710, a second model of the input data is calculated using the model domain sparseness weights to restrict energy to either primary or multiple regions (see FIGS. 6G-H). The model is muted as described earlier, and in step 712 a reverse transform is applied to obtain the primary or multiples. Based on the primary or multiples, in step 714 an image of the surveyed subsurface is generated.

For the specific example illustrated in FIGS. 6A-H, the model domain sparseness weights are defined based on the probability of the primary or multiple's presence at any given tau-slice. Thus, boxes 610 and 612 represent sparseness weights set to zero in the P zone and boxes 614 and 616 represent sparseness weights set to zero in the M zone, while the remaining areas (white areas) relate to sparseness 1.

Setting sparseness weights in this way does not allow any model domain energy inside blocks 610 to 616. FIG. 6H shows the model domain derived using the data weights of FIG. 6G. It is visible in FIG. 6H that the energy relating to primary D has been restricted to the left side of line C due to restrictions imposed by the sparseness weights. This reduces the amount of primary energy in the multiple model leading to primary preservation.

This embodiment outlines a method to derive sparseness weights for deriving a model domain of input traces to better separate signal and noise. The sparseness weights are derived based on the input data and they may vary from gather to gather or data window to data window. The above embodiment is based on a time domain Radon. However, the method illustrated in FIG. 7 may also be applied to frequency domain Radon or time-frequency Radon. The approach of FIG. 7 may be used for a plurality of applications using various input data types, as already described above.

According to another embodiment, a method for deriving joint model-data sparseness weights for a constrained inversion is now discussed. The term “model-data sparseness weights” means that different parts of the input data are subject to different model domain sparseness constraints. For example, while the model domain sparseness weights have the dimensionality of the model domain (ntau, Np), and the data domain sparseness weights have the dimensionality of the data domain (nsamp, Nx), the novel joint model-data domain sparseness weights span both model and data domains, and each trace has its own set of model domain sparseness weights described by (nsamp, Nx, ntau, Np), where Nsamp is the number of input trace samples, Ntau is the number of model domain tau values, Np is number of model domain traces, and Nx is number of data domain traces. Alternatively, it is possible to allow each input trace to have its own sparseness weights; in this case the joint model-data sparseness weights may be of size (ntau, Np, Nx).

There are numerous ways of calculating joint model-data sparseness weights. In general, the joint model-data sparseness weights may be based on a local estimate of the kinematics of the wave-field. This may relate to an estimate of the linear dip of an event, the parabolic curvature of an event, or another kinematic measure. One approach may involve applying dip destruction filtering to a dataset. The result of dip destruction may be an estimate of the slope or dip of energy for each data sample. The joint model-data sparseness weights may allow each sample to be composed only of the model domain dip calculated by the dip destruction slope.

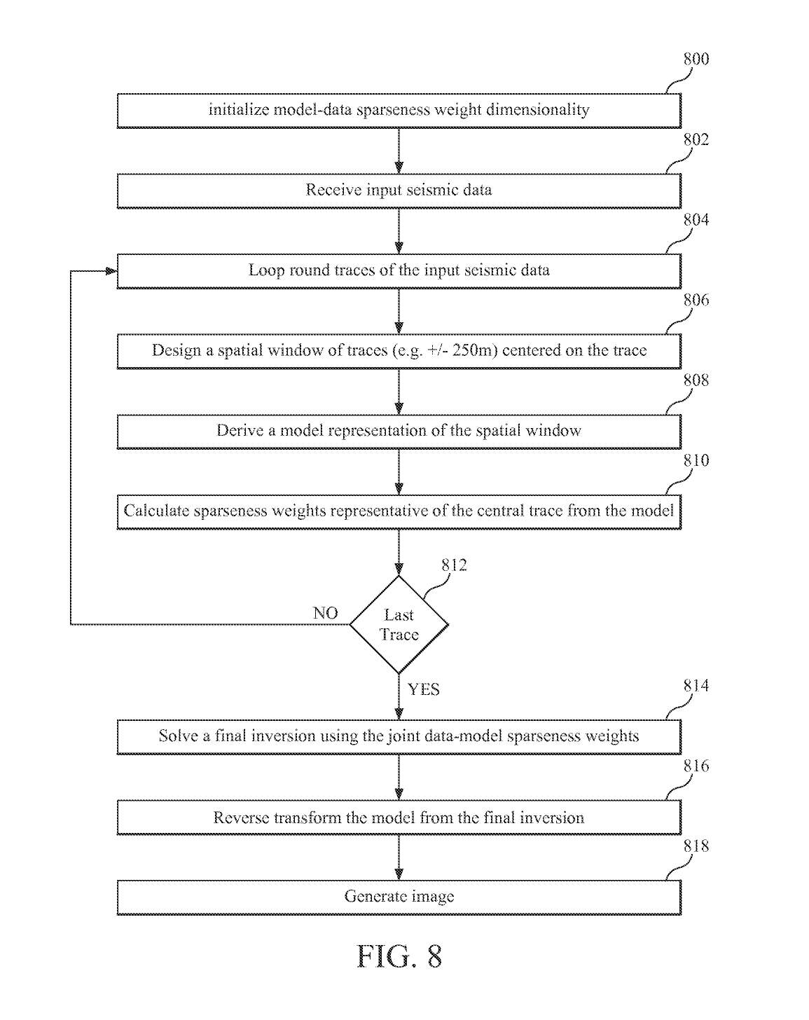

In another embodiment, this novel process includes, as illustrated in FIG. 8, a step 800 of initializing model-data sparseness weight dimensionality (Ntau, Np and Ntra), a step 802 of receiving an input gather (or receiving the seismic data d), and a step 804 of looping through traces of the input seimic data d, a step 806 of selecting (or designing) a spatial window of trace centered on a current trace in the loop. In one application, the window can be +/−250 m. In step 808, a model representation of the spatial window is derived, and this representation may be obtained, for example, using the adjoint operator L^{T} discussed above. In step 810, the sparseness weights are calculated and they represent the central trace from the model. The sparseness weights may be calculated, for example, using the envelope. The weights are stored in a memory device. In step 812, the process determines if all the traces have been processed. If more traces need to be processed, the process returns to step 804 for moving to the next trace. After all the traces from the input seismic data have been processed, the process advances to step 814, in which a final inversion of the seismic data is performed using the joint data-model sparseness weights. In step 816, the process reverse transforms the model resulted from the final inversion and in step 818 an image of the surveyed subsurface is generated.

The sparseness weights may be derived from a model domain of the data in many ways. For example, one strategy is to calculate the envelope of the model domain (it is possible to subsequently raise the envelope to a power). Another strategy could be to try and constrain energy on to a limited number of ps. In this regard, it is possible to receive the model domain and then to loop round time slices of the model domain. During this loop, the method will calculate an average amplitude for a time window centered on the time slice, raise the amplitude to a power, set sparseness weights to zero on the weakest model domain's parameters, and place the manipulated amplitude calculation into the sparseness weights for the time slice. The proposed method of using model-data sparseness weights may be used for many applications, as already discussed above.

The sparse inversion with time-frequency sparseness weights method discussed above may be used in geophysical exploration to overcome aliasing and to separate areas of signal and noise.

In this and other embodiments, algorithms have been described with relation to the attenuation of multiples. However, these approaches are applicable to any inversion problem which may relate to the derivation or application of a filter. Derivation of a filter may involve solving an equation d=Lf, where d is input data, L is a convolution with data, and f is the filter. Application of a filter may involve solving equation d=F′o, where d is input data, o is the output data, and F′ is a filter convolution. F′ may be, for example, a Q-absorption filter, a source resignature filter (for example a farfield signature), or another convolutional filter. Others may relate to the derivation of a model domain representation of the data. Some uses of inversion may be farfield estimation, direct arrival inversion, source designature/deghost, source array compensation, receiver deghosting, receiver array compensation, source re-datuming, receiver re-datuming, cold water statics correction, 4D matching, demultiple (e.g., parabolic, hyperbolic, shifted hyperbola Radon demultiple, tau-p deconvolution, deconvolution, adaptive subtraction), Vz noise attenuation, impulsive denoise, deblending, velocity picking, random noise attenuation, interference noise removal, data reconstruction (regularization or interpolation), signal enhancement (this may involve use of extreme sparseness weights, or masking of weak regions of model space energy before reverse transform), Q-compensation (Q-compensation may be formulated as finding a dataset after q-compensation which when Q is imposed on the data equals the input data), Joint deconvolution, least squares migration (in this case we find a migrated image which when reverse transformed optimally satisfies the input data), Beam migration (beam migrations (controlled beam, Gaussian beam, etc.) involve the migration of bunches of data often on the common offset domain which have been tau-p transformed. The use of the Radon transform described here may be used for the tau-p transform), etc.

The following embodiments discuss various seismic processing methods that may be used together with the embodiments discussed above.

### Mirror Migration of Individual Multiple Orders

Algorithms have been described to separate a dataset containing primaries and multiples into several datasets each individually containing: primaries, first order multiple, second order multiple, third order multiple, etc. Examples of algorithms to do this may include (but are not limited to): Radon demultiple (with different cut values for different multiple orders), Multi-order Green's function modelling, MWD that first isolate primary, run again to isolate first order multiple, run again to isolate second order multiple, etc.

As the multiples offer a different sampling of the subsurface to the primary, it can be of interest to migrate the multiples to improve illumination. One way this may be achieved is by using migrations and mirror migrations, e.g., primary migrated with standard migration; first order multiple migrated with mirror migration; second order multiple migrated with double mirror migration; third order multiple migrated with triple mirror migration; etc.

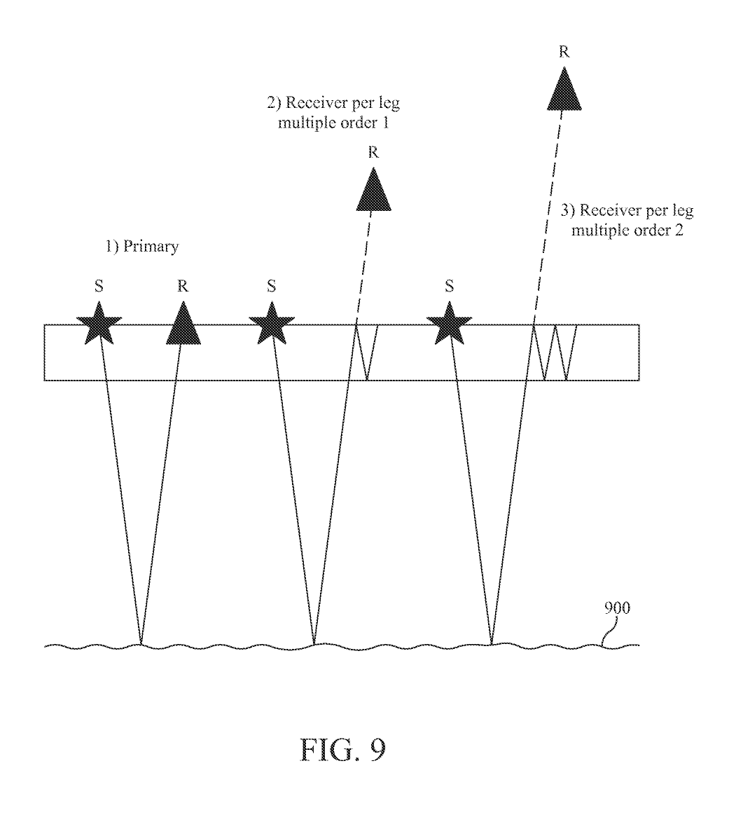

FIG. 9 illustrates the shot S and receiver R migration datums for primary and receiver side peg-leg multiples of order 1 and 2. Any type of migration algorithm may be used (e.g., Kirchhoff, beam, CBM, wave equation, one way, RTM, etc). FIG. 9 shows 3 datasets relating to exclusively primary, receiver pegleg order 1, and receiver pegleg order 2. The solid line shows a raypath for a deep reflector 900 followed by a recording at the receiver R. The mirror receiver position is plotted above the water bottom with the extended dotted line. The mirror migration may be applied on the shot side, or shot and receiver side depending on the type of multiple.

Spherical Divergence Term within Multiple Modelling

The amplitude of arrivals relating to multiples will depend on the reflectivity of the multiple generator and spherical divergence. When a Green's function is applied to an event in the tau-p domain, a higher order multiple is modelled from a lower order multiple (or primary). Whenever this action is performed, the associated delay will vary with slowness. The kinematics of the new event will be different from the generator (generally speaking, the new event will curve more quickly in tau-p). An event in (x-t) is generated from the energy tangential to a linear slope in (tau-p). The faster an event curves in tau-p, the weaker the data after reverse tau-p transform will be. Hence, the reverse transform of this event to the data domain will be weaker than the generator. The reduction in amplitude may relate to spherical spreading.

Some inversion strategies may benefit from balanced input data. In this way, all events may be given equal importance for the minimization. However, balancing input data may result in incorrect handling of spherical spreading following the above discussion. For this reason, it may be beneficial to include an amplitude compensation term within the inversion scheme. This may be outlined as follows:

1) Balancing amplitudes of input data

a. Input data without spherical spreading compensation

b. Calculate balancing function, this may be (where ‘t’ means two-way travel time):
i. Based on analysis of the data
ii. Set proportional to a t-squared function (this may be indicative of amplitude variations below the water layer)
iii. Set proportional to a t function (this may be indicative of amplitude variations within the water layer)
iv. Based on a velocity function
v. Note that the correction may vary depending on if the multiple modelling is performed in the tau-p (cylindrical spreading) or tau-px-py (spherical spreading) domain.
vi. Another balancing function

c. Apply balancing function 1b to data 1a

2) Linear operator from model to data space (L)
a. Receive tau-px-py model
b. Convolve tau-px-py model with multi-order Green's function
c. Reverse tau-px-py transform
d. Apply balancing function from 1b
e. (try to match the result of these operations to the balanced input data; 1c)
   3) Adjoint operator from data to model space (L^{T})
a. Receive (x-t) domain data, initially 1c
b. Apply balancing function from 1b.
c. Forward tau-px-py transform
d. Correlate tau-px-py model with multi-order Green's function

It is possible to change the amplitude behavior of the Green's function based on spherical spreading or for other reasons. This variation may change with time. For example, we may vary the amplitude dependent on the surface of the propagation wavefield, e.g., a sphere. In this case, an embodiment for the multi-order Green's function may be given by:

$${M}_{Ws} = \frac{r}{4 π {R}^{2}} {\sum }_{i = 0}^{∞} \frac{{g}^{i}}{{( i + 1 )}^{2}}$$

### Application of Green's Function Using Ray-Tracing

Methods for applying a Green's function to seismic data using ray-tracing are now explained. Consider the case of modeling a multiple by application of a Green's function in a model domain. Many model domains may be used, but in this case consider the use of tau-p or tau-px-py domain. This may involve using a single order Green's function, for example to calculate order 1 multiples from primaries, order 2 multiples from order 1 multiples, etc. Alternatively, this may include using a Green's function relating to more than one order of multiple, for example designed to convert primaries into all orders of multiples.

For a horizontal multiple generator, this may relate to a convolution in the tau-p domain. In this case the slowness of a primary and the slowness of a multiple may be the same. For a locally dipping multiple generator, the slowness of the primary energy may be different to the slowness of the multiple(s). Given the dip, depth and velocity model relating to the multiple generator, ray tracing may be used to calculate the Green's function timing in tau-p space as well as a change in slowness from primary to multiple.

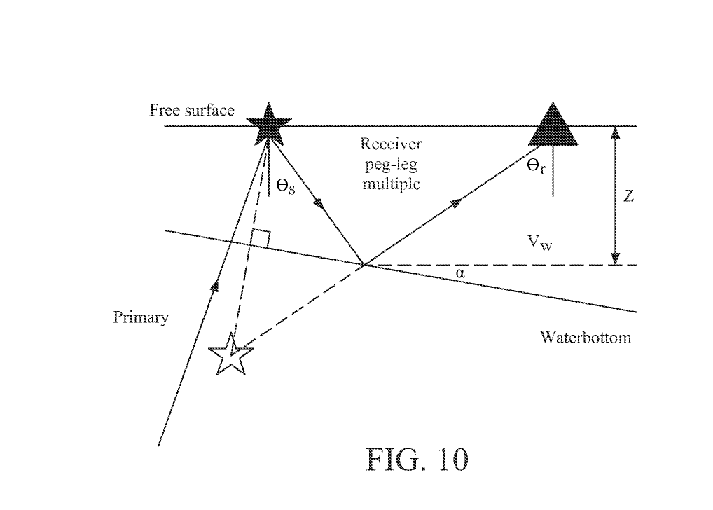

FIG. 10 illustrates the case of a receiver peg-leg multiple generated from a deeper primary. It is possible to consider an incoming primary ray relating to a slowness trace in the tau-p domain. It is possible to add in an associated receiver peg-leg multiple. The primary ray arrives at the surface with angle θₛ to the vertical, reflects at the free surface before being reflected back up from the waterbottom, which dips with angle α to the horizontal. It arrives at the receiver at angle θᵣ to the vertical. As the waterbottom is not horizontal, θₛ≠θᵣ. Using ray tracing (or in this case simple geometry), it is possible to see that θᵣ=θₛ=2α. These angles may be converted to tau-p slownesses using relation sin θ=p/v_{w}, where p is the slowness (the relation may be repeated for source and receiver sides to find pₛ and pᵣ relating to θₛ and θᵣ). The time delay relating to the multiple reflection may also be computed, for example, Δτ=z(p_{zs}+p_{zr}) using relation

$$\frac{1}{{v}_{w}^{2}} = {p}_{x}^{2} + {p}_{y}^{2} + {p}_{z}^{2} .$$

In this case, convolution of the Green's function would relate to a shift of Δτ followed by a change in slowness. In the case a multi-order Green's function is used in the tau-p domain to convert primaries into all orders of multiples, this may be considered as the following flow:

1) Initialize output tau-p domain to zero, mₒᵤ
2) Receive tau-p domain, mᵢₙ
3) Loop round orders of multiple to model

a. Initialize temporary tau-p domain for current order of multiple, mₜₘₚ

b. Loop round slowness traces, pᵢₙ=1 to P
i. Calculate time delay for current trace, Δτ
ii. Calculate output slowness trace relating to current trace, pₒᵤ
iii. Model multiple, mₜₘₚ(pₒᵤ)=mₜₘₚ(pₒᵤ)+r*mᵢₙ(pᵢₙ)e^{2*pi*i*f*Δτ}
iv. Update output model, mₒᵤ(pₒᵤ)=mₒᵤ(pₒᵤ)+mₜₘₚ(pₒᵤ).
   where r is the amplitude of reflection at the waterbottom which may change with reflection angle and may take the form of a spike, small wavelet (e.g., Gaussian), or other simplification for the Earth response. The above flow may be used iteratively to model as many orders of multiple as required.

The principle may be extended to work with any model domain and using ray tracing to relate model parameters of incoming data to an associated multiple. The Green's function may relate to a surface related multiple or interbed multiple, the ray tracing may relate to the waterbottom or a deeper event and may relate to ray tracing across an interface.

### Combination of Different Demultiple Schemes

In one embodiment, it is possible to use the multi-order Green's function based demultiple (MOGIN) approach in combination with other demultiple schemes, e.g., MWD. For example, it is possible to use MOGIN for the low frequencies and MWD for the high frequencies. In one application, it is also possible to use one multiple model to constrain another multiple model, as exemplified in the following possible high level computer code:

1) Input data
2) Calculate MWD multiple model
3) Calculate MOGIN multiple model
4) Adaptive matching of (2) and (3)
5) Adaptive subtraction of (4) from input data (1).

### Estimation of a Multiple Generator

Deconvolution operators may be used to derive information about Green's functions for model based demultiple approaches. This approach may relate to predictive deconvolution operators derived with or without sparse inversion. The deconvolution operator may be derived using an inversion scheme:

d=Lf

where f is the gapped deconvolution operator, d is the input data, and L performs a convolution with the input data shifted by the gap. It is common to pre-multiply each side of the equation by L^{T} to solve a least squares problem:

L^{T}d=L^{T}Lf.

In this case, L^{T}d would relate to a cross-correlation between the input data and a shifted version of the input data and L^{T}L would relate to an auto-correlation of the input. The time shift may be a multiple of the sample interval of may involve a sub-sample shift applied with sinc or Fourier interpolation.

The equations may be solved with iteratively re-weighted least squares inversion using the envelope of an estimate of f. This may involve solving the following:

W^{T}L^{T}d=W^{T}L^{T}LW\hat{f}

which may relate to a scaling of the columns of L. The following scheme may be used:
1) Initialize sparseness weights, W, to unity
2) Solve above least squares problem using current sparseness to find f
3) Update sparseness coefficients of W using the envelope of f
4) Go back to step (2).

The deconvolution operator weights may additionally be constrained by defining a small operator window close to the main peak in the deconvolution operator, e.g.,

1) Initialize sparseness weights, W, to unity,
2) Solve least squares problem using current sparseness to find f,
3) Define new gap and operator length based on result of (2), e.g. a small window around the peak, and

### 4) Go to (2).

The size and position of the active operator may be slowly constrained with the iterative process. This may be used to derive a short operator relating to the water bottom reflection of one or more samples.

To correctly predict the amplitude of all multiple orders it may be necessary to include a second order operator term (e.g., Backus, 1959, “Water reverberations—their nature and elimination,” Geophysics, 24, 233-261). A standard gap deconvolution with an operator length long enough to cover two orders of multiple would have the freedom to achieve this, though it may suffer from contamination by energy appearing between the two autocorrelation peaks. Alternatively, it is possible to derive two short prediction filters relating to the timing of first and second multiple orders. The two filters may have different lengths, for example the first filter may consist of a single sample, and the second filter of a short window of 50 ms for example.

In the case that two single sample operators (f₁ and f₂) are wanted, this would result in the following linear equation:

$$d = Lf$$

$$d = ( {L}_{1} {L}_{2} ) ( \begin{matrix}{f}_{1} \\ {f}_{2}\end{matrix} )$$

where L₁ is a column vector relating to the input data shifted by the timing of the first order generator, and L₂ is the column vector relating to input data shifted by twice the timing of the first order generator. The shift may be a sub-sample shift, for example calculated using a sinc function or Fourier phase shifts.

Alternatively, a single operator may be derived to represent both first and second order operators with the appropriate time shifts and amplitude scaling (e.g. for a short (e.g. spike) first order operator, f₁, centered at time t₁ with peak amplitude a₁, the second order operator may, for example, be given by a short operator centered at time 2t₁, with amplitude −a₁²/4). This may be solved with non-linear inversion (e.g. Stochastic inversion, Ridge regression, Gauss-Newton, etc). Alternatively for a spike operator the amplitude a₁ may be derived, for example, by minimizing the cost function:

$$δ ( {a}_{1} ) = {\sum }_{j = 1}^{N} {( D ( j ) - {a}_{1} {D}^{′} ( j ) + \frac{{a}_{1}^{2}}{4} {D}^{″} ( j ) )}^{2}$$

with respect to a₁. Here, D is the recorded data, D′ is the recorded data shifted in time by t₁, and D″ is the recorded data shifted in time by 2t₁. The summation may be carried out, for example, over all N samples comprising each trace. The cubic equation in a₁, resulting from the minimization condition, can then be solved by standard analytic methods.

The operators may be derived in the tau-p domain (this may relate to sea surface datum data after receiver deghosting). The operators may be allowed to change with slowness (px/py) and space (for example to cover a change in reflectivity with angle relating to a multiple generator). The operators may be used directly for demultiple (e.g. constrained predictive deconvolution), used to define MWD operator timings, to define multi-order Green's function inversion timing and amplitude/reflectivity operators or other strategies requiring a Green's function or other representation of the Earth response.

The methods of sparseness weights and windowing may be used separately or combined. The equations may be solved with linear or non-linear inversion using for example, conjugate gradients, LU decomposition, Cholesky factorization, etc.

### Water Layer Multiple Modelling

As per existing method, multi-order Green's functions may be used to model a primary reflection which is consistent with the multiples. A multi-order Green's function may be constructed for any single order Green's function. A multi-order Green's function for peg leg multiples, M_{P}, may be modelled with:

$${M}_{P} = {\sum }_{{i}_{s} = 0}^{∞} {G}_{s}^{{i}_{s}} {\sum }_{{i}_{r} = 0}^{∞} {G}_{r}^{{i}_{r}} = \frac{1}{( 1 - {G}_{s} ) ( 1 - {G}_{r} )}$$

where Gₛ and Gᵣ are source and receiver side single order Green's functions.

In the case of multiples which have exclusively travelled within the water layer, the multi-order Green's function may be given by:

$${M}_{W} = {\sum }_{i = 0}^{∞} {G}^{i} = \frac{1}{( 1 - G )} .$$

This approach may be applied in the source or receiver domain. For towed streamer acquisition it may be preferable to apply in the shot domain where sampling is better. In this case, G would be the receiver side Green's function. An alternative multi-order Green's function may be defined to convert primary only into multiples, e.g., (M_{W}−1).

Either form of Green's function may be applied with convolution/summation or combined with linear Radon as per the prior art.

In one application, there is one recorded dataset which will contain both water layer only multiples and peg leg multiples. One approach could be to first deal with the water-layer only multiples, and then to consider the peg leg multiples. This could involve:

1) Selecting the water layer primary and water layer only multiples with data domain muting, and
2) Solving an inversion to find the primary which when convolved with the multi-order Green's function M_{W} satisfies the data from (1).

Alternatively, it is possible to

1) Select the water layer multiples with a mute, and
2) Solve an inversion to find the primary which when convolved with the multi-order Green's function (M_{W}−1) satisfies the data from (1).

The tau-p model may be further constrained using model domain weights based on the anticipated timing of the primary water bottom reflection, e.g., relating to a tau window along the tau of:

2zp_{z}

where z is the water depth and p_{z} is the vertical slowness, which is given by:

$$\frac{1}{{v}_{w}^{2}} = {p}_{x}^{2} ( m ) + {p}_{y}^{2} ( m ) + {p}_{z}^{2} ( m ) .$$

Once the primary estimate has been found, it may be used to estimate the water layer primary and multiples in the data. This may then be used in a number of ways:

1) Add the primaries into an output dataset.
2) Subtract water layer primaries and multiples from the recorded data
3) Solve a second inversion to model primaries and multiples relating to peg-leg multiples following the first equation (Mₚ).

In the case we consider the pure water layer multiples as receiver side multiples we have:

$${M}_{W} = {\sum }_{i = 0}^{∞} {G}_{r}^{i} = \frac{1}{( 1 - {G}_{r} )}$$

which may be converted to peg leg multiples of the form:

$${M}_{P} = {\sum }_{{i}_{s} = 0}^{∞} {G}_{s}^{{i}_{s}} {\sum }_{{i}_{r} = 0}^{∞} {G}_{r}^{{i}_{r}} = \frac{1}{( 1 - {G}_{s} ) ( 1 - {G}_{r} )}$$

Therefore, it is possible to calculate a correction term, C, to convert pure water layer multiples to peg leg multiples:

$$C = \frac{1}{( 1 - {G}_{s} ) ( 1 - {G}_{r} )} - \frac{1}{( 1 - {G}_{r} )} = \frac{{G}_{s}}{( 1 - {G}_{s} ) ( 1 - {G}_{r} )}$$

and this C is added to the recorded data.

This process may also be described as follows:

1) convolve the water bottom primary estimate with a MOGF such that, when the result is added to the recorded input data, it increases the amplitude of the recorded water layer multiples so they have the same amplitude behavior as peg-leg multiples. An example of such a MOGF is Gₛ/((1−Gₛ)(1−Gᵣ)), and
2) Solve an inversion on the resulting data to model primaries and multiples relating to peg-leg multiples following the first equation.

The input seismic data d discussed in the previous embodiments may include only pressure measurements, or only particle motion measurements, or both pressure and particle motion measurements. The transforms used in the previous embodiments may be made from the time-space domain to the Radon domain (hyperbolic, parabolic, etc), but also to frequency-wave number domain, tau-p domain, rank reduction, singular value decomposition (SVD), and curvelet domain. In one application, the step of generating a model m includes solving an inverse problem based on linear operator L and the input seismic data d, and applying an L^{T} transform to the model p to obtain a seismic dataset indicative of ghost wave-fields, with the L^{T} transform combining primary attenuation and interpolation. The L^{T} transform may be applied after a denoising step is applied to model m. In one application, an amount of noise is reduced by controlling sparseness weights when the model domain is derived. The sparseness weights may also be derived to mitigate aliasing, which may be especially useful if only hydrophone or only particle velocity data is input. The sparseness weights may be derived initially at low frequencies (e.g., at values less than 10 Hz) and used to constrain the model at high frequencies. The sparseness weights may be updated during several iterations, e.g., 0-10 Hz model is used to constrain a 0-20 Hz model which is used to constrain a 0-40 Hz model, etc. The sparseness weights may be derived from the envelope of the tau-p model at each iteration. Processing in the model domain may also include muting, scaling, resampling, removing cross-talk or interference noise, re-datuming and vector rotation, as will be discussed later.

The seismic dataset d may be generated at positions in-between the receivers, i.e., having any output y relative to the ys of the receivers and/or streamers. The positions may be at a different datum than the receivers, or the positions are designed to match positions of receivers from another seismic survey, or the positions are equidistant from input streamers on which the receivers are distributed, or the positions are on a regular grid.

In another embodiment, the L matrix discussed above may be used for time-lapse studies where one or more vintage datasets consist of measurements at different spatial coordinates and/or receiver depths than new acquisition measurements. Once the model m has been found, it may be used to output data at the exact x-y coordinates and depths of any prior vintage (baseline) dataset or other positions. This allows accurate comparison of vintage datasets and reconstructed monitor datasets. Up-going, down-going or a combination of both may be used for this purpose. For example, a base hydrophone-only dataset will contain primary and ghost data, and interpolation or deghosting of this base dataset may not be possible. In this case, it can be of interest to output the monitor data (the later-in-time survey data) at the x-y-z recording coordinates of the baseline, including primary and ghost. With multiple datasets, it may be of interest to interpolate all vintages on to a common sampling that includes positions not occupied by any dataset. The positions could be designed so that the interpolation distance on average is minimum, i.e., the positions are selected as close as possible to the input data positions because the interpolation quality at positions further away is expected to degrade.

According to another embodiment, different x/y offsets and depths may be used for up-going and down-going datasets, for example, to improve illumination or to match wave-field propagation to a vintage dataset or datasets.

The scheme may be used to output particle velocity data onto a second set of traces to help interpolation, e.g., if a first base dataset includes only hydrophone data and a monitor dataset includes multi-component data, it is possible to interpolate the monitor dataset to the positions of the base and then use the base hydrophone combined with interpolated monitor particle velocity for interpolation of the base hydrophone data. One example is the use of a monitor hydrophone/particle motion dataset for outputting particle velocity measurements on a vintage dataset. Interpolated particle velocity measurements combined with original pressure measurements from the vintage data can be used for interpolation of the vintage dataset. Alternatively, particle motion data may be extrapolated within a shot gather from near offsets (where accelerometer measurements are available) to far offsets (where accelerometers were not installed).

Input data for any of the above methods may be in any pre-stack domain, for example shot, receiver, midpoint, conversion point or cross-spread. The intention is that any of the above implementations would be made on a computer. While much of the previous embodiments discussed use multi-component measurements, it should be noted that where signal-to-noise ratio and sampling allows, the scheme(s) may be used with fewer data, e.g., hydrophone data only or particle motion data only. In particular, this may require more demands on sparseness constraints, e.g., beginning by solving the equations for a low frequency bandwidth which is not aliased, and using the model to derive sparseness weights for the higher frequency model solution. Also, it may be possible to use as input pressure and particle motion data and to generate an output that includes only pressure wave-fields or only particle motion wave-fields, as now discussed.

The following comments relate to the design and use of the L matrix discussed above. Particle velocity data may be obtained from individual sensors, or summed (average or weighted sum) to form a receiver group. Particle velocity data may have been acquired directly or may be computed from accelerometer sensors (for example, by integration). Other types of particle motion sensor may be available. While the above embodiments relate to modeling of particle velocity data, a differentiation step may be included in the matrix formulations to work directly with accelerometer data. The differentiation could be applied in the time or the frequency domain. Receivers generate a marine streamer dataset that is achieved in a narrow, wide or multi-azimuth, coil shooting or any configuration towed with constant or variable depth (e.g., slant streamer, BroadSeis profile, over-under streamers), and the seismic data is generated with an air gun, marine vibrator, or other source element. Source elements may be fired according to any known scheme, e.g., continuously, simultaneously, flip-flop, etc. Receivers may also be used in ocean bottom survey (nodes, cables, or other with air gun, marine vibrator or other source), land dataset (dynamite, vibrator or other source), or a combination of two or more dataset types. The data may have been calibrated before applying the processes discussed herein, or calibration scalars may be included in the matrix formulations noted in the embodiments. Water velocity terms may be constant or allowed to vary with depth. Variation with depth can be of use for OBS datasets where there is a water velocity gradient. The methods may be used for one-sided or split-spread acquisition.

Equations described herein may be solved in the time domain or a spectral domain (e.g., frequency, Laplace, z-transform, etc.), wavelet domain (e.g., curvelet or other). Model m may be found through any inversion method, e.g., conjugate gradients, LU decomposition, Cholesky factorization, etc. Model m may be derived to represent all traces in the input shot, or may work on a subset of data from the input shot, for example, spatial windows of a given number of channels. Sparseness weights may be used in the inversion to improve results, for example, where there is poor signal-to-noise ratio or to overcome aliasing; e.g., iteratively reweighted least squares beginning with low frequencies and working up to higher frequencies. Other model domains may be used, for example, frequency-wavenumber (FK), parabolic Radon, hyperbolic Radon, etc. In fact, any fixed datum model domain may be defined as long as it can be reverse transformed, redatumed and reghosted for both hydrophone and particle velocity sensor data. Alternatively, an iterative approach similar to the anti-leakage tau-p transform can be used which also exhibits sparseness properties. No matter how the model is formed, it needs to simultaneously reproduce the hydrophone and particle velocity measurements through application of an operator, e.g., L.

Due to differing signal to noise ratio of hydrophone and particle velocity data, it may be necessary to define the inversion so as to satisfy the hydrophone data for a broader bandwidth than the particle velocity data. This may be implemented by including a frequency dependent scaling term into the matrix or bandpass filtering the model and data for different conjugate gradient passes either by multiplication in the frequency domain or convolution by a bandpass filter in the time domain. For example, application of L may include a bandpass filter so that when applied the bandwidth of particle velocity components is 25 Hz to 250 Hz, whereas the bandpass filter for hydrophone data is 2 Hz to 250 Hz. Conjugate gradient inversion begins by computing L^{T}d from d, and continues by combining frequency filtering into L. The bandwidth of L^{T}d will automatically be adjusted and be consistent for the later applications of L and L^{T} in the conjugate gradient flow.

Some of the above discussed methods are summarized as follows.

According to a first method for processing input seismic data d, the method includes a step of receiving the input seismic data d recorded in a data domain; a step of solving a linear inversion problem constrained by input seismic data d to obtain a model domain energy, wherein the linear inversion problem is dependent on sparseness weights that are simultaneously a function of both time and frequency; a step of reverse transforming the model domain energy to the data domain; and a step of generating an image of a surveyed subsurface based on the reverse transformed model domain energy. In one application, the sparseness weights are model domain sparseness weights. In another application, the sparseness weights are data domain sparseness weights. In one embodiment, the linear inverse problem uses an iterative approach that repeatedly applies operator L to a calculated model domain and adjoint operator L^{T} to estimated data.

The method may further include a step of calculating a highest non-aliased frequency range and a step of using the sparseness weights from the highest non-aliased frequency range to define sparseness weights at higher frequencies. In one application, the highest non-aliased frequency range is calculated based on a maximum parabolic move-out parameter, a maximum offset of a given window, and an offset spacing. The linear inversion problem may derive a Radon domain. In one application, the linear inversion problem derives a convolutional filter. In another application, the linear inversion problem derives an output trace. The sparseness weights may be updated during a solution of the linear inverse problem. In one embodiment, the sparseness weights are calculated by estimating an envelope of a corresponding trace in the model domain.

According to another embodiment, there is a method for processing seismic data that includes a step of receiving a first seismic dataset, a step of calculating model domain sparseness weights based on the first seismic dataset, a step of receiving a second seismic dataset, a step of calculating a model domain of the second seismic dataset based on the model domain sparseness weights of the first seismic dataset, and a step of generating an image of a subsurface based on the model domain. The second seismic dataset is a sub-set of the first seismic dataset and the model domain is a different domain to the seismic dataset.

In one application, the first and second model domains are iteratively calculated using conjugate gradients. The sparseness weights may be iteratively calculated beginning with a low frequency to dealias high frequencies. The model domain may be a Radon domain. In one application, the first and second datasets correspond to a same subsurface. In another application, the first seismic dataset is more densely sampled than the second seismic dataset. In still another application, the first seismic dataset has more seismic sensor types that the second seismic dataset. The sparseness weights may be model domain sparseness weights and they may be calculated using a model estimate of the first dataset. In another application, data domain sparseness weights are used to constrain the inversion.

In still another embodiment, there is a method for processing seismic data that includes a step of receiving an input seismic dataset recorded in a first domain, a step of calculating at least two model domains corresponding the seismic dataset in a different domain, a step of reverse transforming the at least two model domains to the first domain, and a step of calculating an image based on the reverse transformed data. The at least two model domains represent spatial sub-sets of the input seismic dataset and are computed simultaneously with a single linear inversion. The different domain may be a Radon domain. The single linear inversion may use a reverse Radon transform and/or a spatial tapering. An input trace constrains the single linear inversion using a reverse Radon transform from more than one Radon model. The single linear inversion may use data or model domain sparseness weights. The method may include a step of defining the model domain into a primary zone and a multiples zone at a cut, and/or a step of calculating an energy of the primary zone and an energy of the multiples zone, and/or a step of calculating a ratio of the primary energy and the multiples energy, and/or a step of calculating the sparseness weights based on the ratio.

According to another embodiment, there is a method for processing seismic data that includes a step of receiving an input seismic dataset recorded in a first domain, a step of calculating a model domain corresponding to the input seismic dataset in a different domain using joint data-model domain sparseness weights, a step of reverse transforming the model domain to the first domain, and a step of calculating an image based on the reverse transformed data. The joint data-model domain sparseness weights enable different data domain samples to be constrained by different model domain sparseness weights.

The model domain may be a Radon domain. The joint data-model domain sparseness weights are a function of space, time, and Radon trace. The joint data-model domain sparseness weights may be derived from a local estimate of model kinematics. The model kinematics relate to slownesses computed using a dip destruction filter. In one application, the model kinematics relate to a windowed Radon model of the input data.

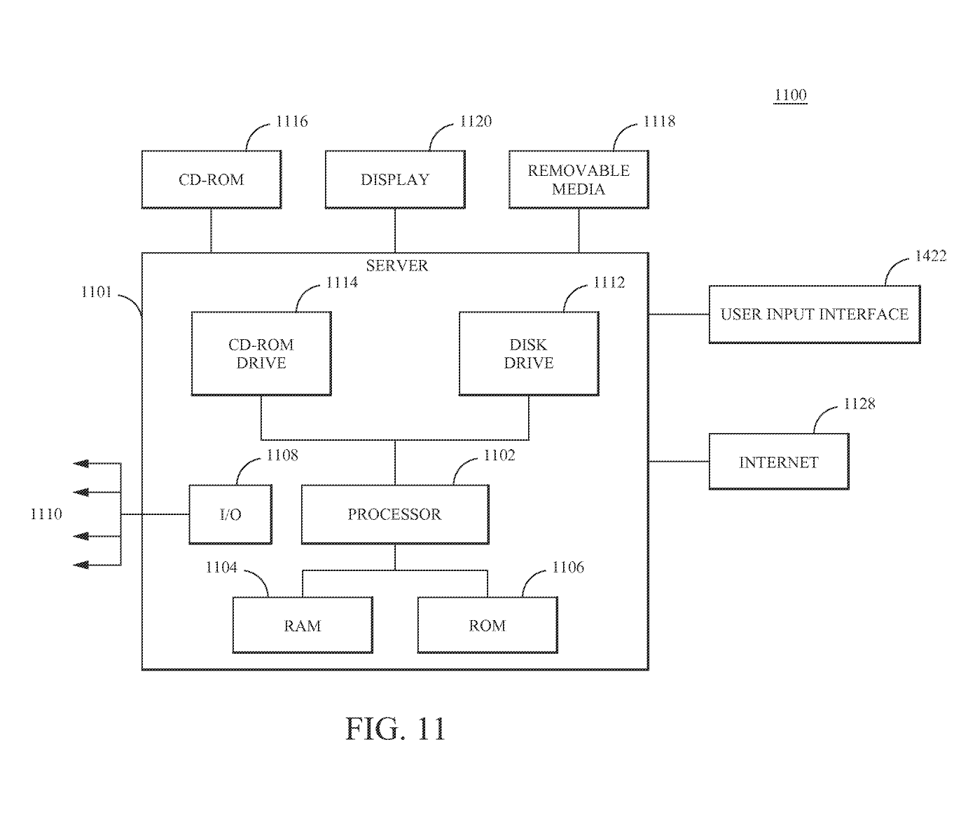

The above-discussed procedures and methods may be implemented in a computing device as illustrated in FIG. 11. Hardware, firmware, software or a combination thereof may be used to perform the various steps and operations described herein. Computing device 1100 of FIG. 11 is an exemplary computing structure that may be used in connection with such a system.

Exemplary computing device 1100 suitable for performing the activities described in the exemplary embodiments may include a server 1101. Such a server 1101 may include a central processor (CPU) 1102 coupled to a random access memory (RAM) 1104 and to a read-only memory (ROM) 1106. ROM 1106 may also be other types of storage media to store programs, such as programmable ROM (PROM), erasable PROM (EPROM), etc. Processor 1102 may communicate with other internal and external components through input/output (I/O) circuitry 1108 and bussing 1110 to provide control signals and the like. Processor 1102 carries out a variety of functions as are known in the art, as dictated by software and/or firmware instructions.

Server 1101 may also include one or more data storage devices, including hard drives 1112, CD-ROM drives 1114 and other hardware capable of reading and/or storing information, such as DVD, etc. In one embodiment, software for carrying out the above-discussed steps may be stored and distributed on a CD-ROM or DVD 1116, a USB storage device 1118 or other form of media capable of portably storing information. These storage media may be inserted into, and read by, devices such as CD-ROM drive 1114, disk drive 1112, etc. Server 1101 may be coupled to a display 1120, which may be any type of known display or presentation screen, such as LCD, plasma display, cathode ray tube (CRT), etc. A user input interface 1122 is provided, including one or more user interface mechanisms such as a mouse, keyboard, microphone, touchpad, touch screen, voice-recognition system, etc.

Server 1101 may be coupled to other devices, such as sources, detectors, etc. The server may be part of a larger network configuration as in a global area network (GAN) such as the Internet 1128, which allows ultimate connection to various landline and/or mobile computing devices.

The above embodiments have presented various algorithms for processing input seismic data d. Those embodiments are now summarized for a better understanding of the claimed methods. Literal references are provided for each embodiment and numeral references are provided for the various features associated with a given embodiment. The following embodiments are just exemplary and not intended to limit the invention. The features for the embodiments are listed with a corresponding numeral reference and each feature may work with any other feature of a respective embodiment. Note that all these features are disclosed above and the following section only organizes these features in an easy to follow way. All the features listed next may be implemented into a computing device such that these calculations are automatically performed. Thus, the processor of a computing device may be configured to execute any of the following features, in combination or not. However, the following list of features is not intended to be exhaustive and other combinations of these features are contemplated.

The disclosed exemplary embodiments provide a computing device, software instructions and a method for seismic data processing. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for processing input seismic data d, the method comprising:
receiving the input seismic data d recorded in a data domain;
solving a linear inversion problem constrained by input seismic data d to obtain a model domain and its energy, wherein the linear inversion problem is dependent on sparseness weights that are simultaneously a function of both time and frequency;
reverse transforming the model domain energy to the data domain; and
generating an image of a surveyed subsurface based on the reverse transformed model domain energy.

2. The method of claim 1, wherein the sparseness weights are model or data domain sparseness weights.

3. The method of claim 1, wherein the sparseness weights are joint data-model domain sparseness weights and the joint data-model domain sparseness weights enable different data domain samples to be constrained by different model domain sparseness weights.

4. The method of claim 1, wherein more than one model domain is computed at the same time within a single inversion and an input trace is dependent on more than one model domain.

5. The method of claim 1, wherein sparseness weights derived based on the input data are used to derive another model domain representing a sub-set of the input dataset.

6. The method of claim 5, wherein the seismic dataset is spatially more densely sampled than the sub-set of the input seismic dataset.

7. The method of claim 5, wherein the seismic dataset has been recorded with more seismic sensor types that the sub-set of the input seismic dataset.

8. The method of claim 1, wherein the linear inverse problem uses an iterative approach that repeatedly applies operator L to a calculated model domain and an adjoint operator L^{T} to estimated data.

9. The method of claim 1, further comprising:
calculating a highest non-aliased frequency range; and
using the sparseness weights from the highest non-aliased frequency range to define sparseness weights at higher frequencies.

10. The method of claim 1, where the linear inversion problem derives a Radon domain.

11. The method of claim 1, wherein the linear inversion problem derives a convolutional filter.

12. The method of claim 1, wherein the linear inversion problem derives an output trace.

13. The method of claim 1, wherein the sparseness weights are iteratively updated during a solution of the model domain.

14. The method of claim 1, wherein the sparseness weights are calculated by estimating an envelope of a corresponding trace in the model domain.

15. A computing device for processing input seismic data d, the computing device comprising:
an interface that receives the input seismic data d recorded in a data domain; and
a processor connected to the interface and configured to,
solve a linear inversion problem constrained by input seismic data d to obtain a model domain and its energy, wherein the linear inversion problem is dependent on sparseness weights that are simultaneously a function of both time and frequency,
reverse transform the model domain energy to the data domain, and generate an image of a surveyed subsurface based on the reverse transformed model domain energy.

16. The computing device of claim 15, wherein the sparseness weights are model or data domain sparseness weights.

17. The computing device of claim 15, wherein the sparseness weights are joint data-model domain sparseness weights and the joint data-model domain sparseness weights enable different data domain samples to be constrained by different model domain sparseness weights.

18. The computing device of claim 15, wherein more than one model domain is computed at the same time within a single inversion and an input trace is dependent on more than one model domain.

19. The computing device of claim 15, wherein sparseness weights derived based on the input data are used to derive another model domain representing a sub-set of the input dataset.

20. A non-transitory computer readable medium storing executable codes which, when executed on a computer, makes the computer perform a method for processing input seismic data d, the instructions comprising:
receiving the input seismic data d recorded in a data domain;
solving a linear inversion problem constrained by input seismic data d to obtain a model domain and its energy, wherein the linear inversion problem is dependent on sparseness weights that are simultaneously a function of both time and frequency;
reverse transforming the model domain energy to the data domain; and
generating an image of a surveyed subsurface based on the reverse transformed model domain energy.
